(19) United States
(12) Patent Application Publication
(10) Pub. No.: US 2004/0029453 A1
(43) Pub. Date: Feb. 12, 2004

(54) Low voltage connector

(76) Inventors: John Denison, Lake Villa, IL (US); William L. Richter JR., Antioch, IL (US)

Correspondence Address: BRINKS HOFER GILSON & LIONE, P.O. Box 10395, Chicago, IL, 60610, US

(21) Appl. No.: 10/216,076

(22) Filed: Aug. 9, 2002

(51) Int. Cl. H01R 9/22

(52) U.S. Cl. 439/709

(57) ABSTRACT

A low voltage connector is provided. The low voltage connector includes a housing and a wire terminal connected thereto. An insulation barrier member is located adjacent the terminal. The insulation barrier member is capable of allowing only a stripped wire access to the terminal whereby only a wire without insulation can be connected to the terminal.

### FIELD OF THE INVENTION

The present invention relates generally to a low voltage connector. More particularly, this invention relates to a low voltage connector that helps prevent the introduction of an insulation material into the terminal area of the connector.

### BACKGROUND OF THE INVENTION

Low voltage outdoor lights are well known among homeowners and landscape contractors. Such lighting is typically used for outdoor decorative lighting to highlight various outdoor landscaping and/or architectural features of a home or building. These lighting elements are also useful for outdoor security applications.

There are many different styles of outdoor low voltage light fixtures. For example, Intermatic, Inc. sells many such outdoor light fixtures. One type of outdoor light fixture is secured to the ground via a stake. A low voltage electrical supply cable is connected to the light fixture. The low voltage electrical supply cable can be buried under ground and connected to a remote power supply. In particular, the remote power supply can include a transformer in order to output the required low voltage power used by the outdoor light fixture. The remote power supply is typically connected to the power supply of an associated home or building.

An electrical connector is used to connect the low voltage electrical supply cable to the power supply. It is well known that the low voltage electrical supply cable include insulation around a wire core. However, the insulation must be stripped from the wire in order for the wire core to properly contact the terminal portion of the electrical connector. Accordingly, any attempt to connect the insulated portion of the low voltage electrical supply cable to the terminal(s) of an electrical connector can be problematic.

Therefore, there is a need for an improved low voltage electrical connector that is useful to prevent the improper insertion of a low voltage electrical supply cable having insulation thereon into the terminal portion of a low voltage electrical connector.

### SUMMARY OF THE INVENTION

The present invention is directed to an improved low voltage electrical connector. More specifically, the present invention is directed to an electrical connector that prevents the introduction of an insulated wire into the terminal portion of the connector. As a result, a user will be generally prevented from improperly connecting an insulated wire to the terminal portion of the electrical connector.

According to a first aspect of the present invention, a low voltage connector is provided. The low voltage connector includes a housing and a wire terminal connected thereto. An insulation barrier member is located adjacent the terminal. The insulation barrier member is capable of allowing only a stripped wire access to the terminal whereby only a wire without insulation can be connected to the terminal.

According to a second aspect of the present invention, a low voltage connector is provided. The low voltage connector includes a housing and a teeter terminal connected thereto. An inverted U-shaped insulation barrier member is located adjacent the terminal. The insulation barrier member allows only a wire without insulation access to the terminal.

The present invention, together with attendant objects and advantages, will be best understood with reference to the detailed description below in connection with the attached drawings.

### BRIEF DESCRIPTION OF THE DRAWINGS

FIG. 1 is a perspective view of a low voltage electrical connector in accordance with a first embodiment of the present invention with a low voltage electrical cable or wire shown connected to the connector;

FIG. 2 is a perspective view of the low voltage connector of FIG. 1 with the terminal portion of the electrical connector removed; and

FIG. 3 is a side view of the low voltage connector of FIGS. 1-2 with the terminal portion of the electrical connector removed.

### DETAILED DESCRIPTION OF THE PREFERRED EMBODIMENTS

The invention is described with reference to the drawings in which like elements are referred to by like numerals. The relationship and functioning of the various elements of this invention are better understood by the following detailed description. However, the embodiments of this invention as described below are by way of example only, and the invention is not limited to the embodiments illustrated in the drawings. It should also be understood that the drawings are not to scale and in certain instances details have been omitted which are not necessary for an understanding of the present invention, such as conventional details of fabrication and assembly.

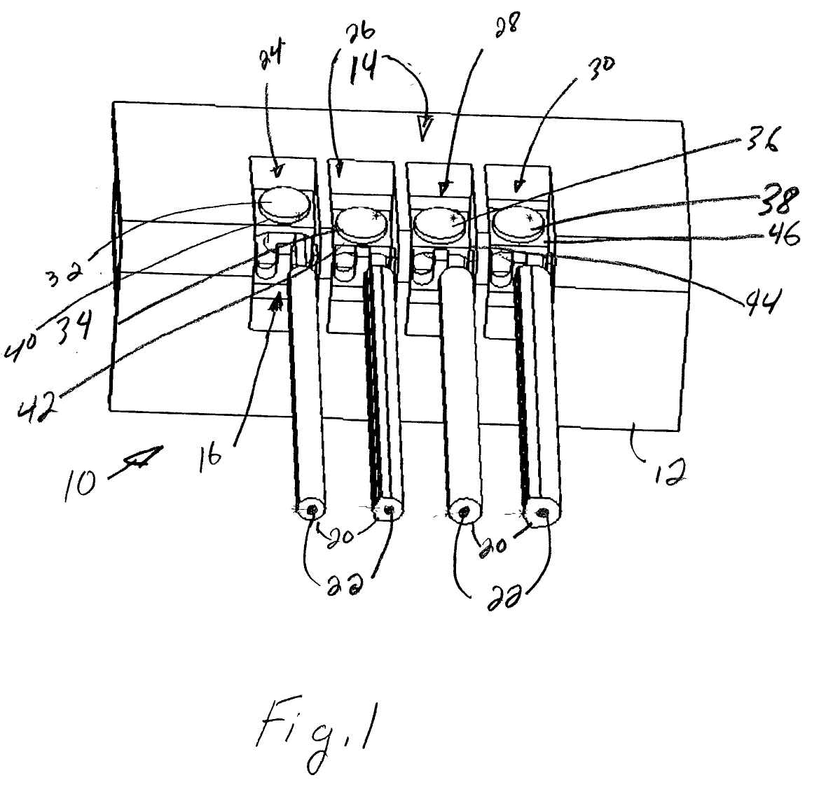

Referring to the drawings, FIGS. 1-3 show an embodiment of the present invention, and particularly, a low voltage electrical connector 10. The low voltage electrical connector 10 may be integrally formed, as shown in the embodiment of FIGS. 1-3, with a transformer and/or other elements. Alternatively, the low voltage electrical connector may be formed as a separate element that is connected to a transformer and/or other elements. In one embodiment, the low voltage connector 10 is intended to be used with a power pack (which includes a transformer) sold with low voltage outdoor lighting systems manufactured by Intermatic, Inc. of Spring Grove, Ill. In particular, the low voltage electrical connector 10 could be connected to a plurality of outdoor lighting fixtures and other associated elements such as a photocell. One example of such a system is the product sold under the name MALIBU® by Intermatic, Inc. However, it should be recognized the present invention has broad application and may be used generally where a low voltage connection is necessary.

The low voltage electrical connector 10, illustrated in FIGS. 1-3, includes a housing 12, a terminal portion 14 and an insulation barrier member 16. Wires 20, particularly the stripped wire cores 22, are shown connected to the terminal portion 14 of the low voltage electrical connector 10. The housing 12, in the illustrated embodiment, is integrally formed from a plastic material with a power pack such as those manufactured by Intermatic, Inc. under Part No. ML88T. Yet, it should recognized that the housing 12 could also be formed as a separate element or used with elements other than power packs. The terminal portion 14 includes, in the illustrated embodiment, four wire terminals 24 (shown in an open state), 26, 28, 30 each including a metal teeter terminal screws 32, 34, 36, 38 and associated wire engagement portions 40, 42, 44, 46. A metal contact element is positioned beneath each wire core 22 in the housing 12 (not shown). The apertures 49A receive the teeter terminal screws 32-38 after they have passed through the metal contact element. The apertures 49B receive a tab extending downward from the metal contact element. While four terminals 24-30 are shown, it should be recognized that less than four terminals could be implemented or more than four terminals could be implemented. Also, the type terminal could also be changed to suit the needs of a particular user. For example, terminals such as pressure terminals or other known terminals could also be used with the present invention.

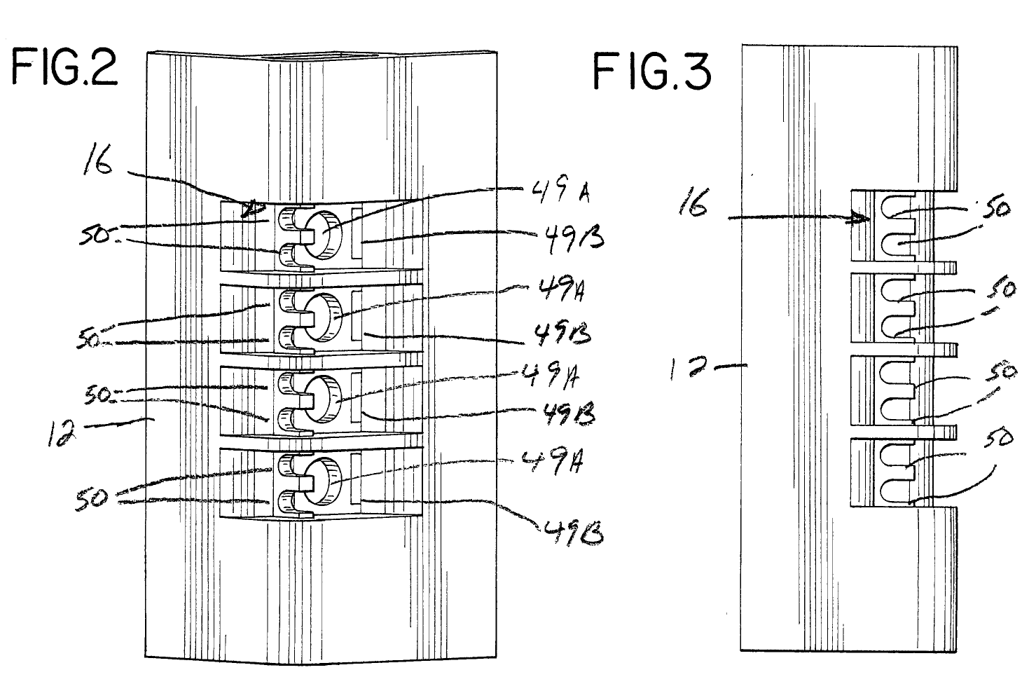

The insulation barrier member 16, best shown in FIGS. 2-3, includes a plurality of inverted generally U-shaped portions 50. Each U-shaped portion 50 is intended to create a channel through which only a stripped wire or wire core 22 may pass. Each U-shaped portion 50 creates a channel narrow enough to substantially prevent insulated wires 20 from passing into a selected terminal 24-30. In one preferred embodiment, the U-shaped portion has a height of 0.2 inches, a thickness of 0.09 inches and base radius of curvature of 0.055. In operation, it is intended that a user be required to strip the insulated wires 20 so as to expose only the wire core 22 in order to connect it to the associated terminal 24-30. The U-shaped portion 50 is sized so as to prevent non-stripped wires from 12 gauge to 18 gauge from passing into the terminal portion 14 of the low voltage electrical connector 10. Accordingly, the insulation barrier member 16 is intended to prevent the improper insertion of an insulated wire into contact with the terminal portion 14.

The embodiments described above and shown herein are illustrative and not restrictive. The scope of the invention is indicated by the claims rather than by the foregoing description and attached drawings. The invention may be embodied in other specific forms without departing from the spirit of the invention. For example, the number of terminals used with the present invention may be changed to suit the needs of a particular application. Accordingly, these and any other changes which come within the scope of the claims are intended to be embraced herein.

We claim:

1. A low voltage connector, comprising:
a housing;
a wire terminal connected to the housing;
an insulation barrier member adjacent the terminal capable of allowing only a stripped wire access to the terminal whereby only a wire without insulation can be connected to the terminal.

2. The connector of claim 1 wherein the insulation barrier member includes a curved portion.

3. The connector of claim 2 wherein the wire terminal is a teeter terminal.

4. The connector of claim 3 wherein a plurality of teeter terminals are connected to the housing.

5. The connector of claim 4 wherein the housing is integrally connected to a power supply.

6. The connector of claim 4 wherein the housing is a separate element connected to a power supply.

7. The connector of claim 4 wherein the insulation barrier member includes at least one inverted U-shaped opening.

8. The connector of claim 4 wherein the wire terminal includes three or more teeter terminals and the insulation barrier member includes three or more inverted U-shaped openings.

9. The connector of claim 8 wherein the insulation barrier member is formed from a plastic material.

10. The connector of claim 9 wherein the teeter terminal is formed from a metal material.

11. A low voltage connector, comprising:
a housing;
a teeter terminal connected to the housing;
an inverted U-shaped insulation barrier member adjacent the terminal capable of allowing only a wire without insulation access to the terminal.

12. The connector of claim 11 wherein the housing is formed from a plastic material

13. The connector of claim 12 wherein the teeter terminal is formed from a metal.
